(19) United States
(12) Patent Application Publication
(10) Pub. No.: US 2019/0077589 A1
(43) Pub. Date: Mar. 14, 2019

(54) TEA BAG WITH STRING ATTACHED STEEP INDICATOR

(71) Applicant: Alexander John Garden, Tiburon, CA (US)

(72) Inventor: Alexander John Garden, Tiburon, CA (US)

(21) Appl. No.: 16/186,276

(22) Filed: Nov. 9, 2018

Related U.S. Application Data
(60) Provisional application No. 62/615,748, filed on Jan. 10, 2018.

(51) Int. Cl. B65D 85/812; A23F 3/16

(52) U.S. Cl. CPC B65D 85/812; B65D 2203/00; A23F 3/16

(57) ABSTRACT

A tea bag system is disclosed that includes a tea bag, a tea bag string, a tea bag tag, and a steep indicator. The tea bag includes a water permeable material that contains tea leaves. The water permeable material enables tea particulates from the tea leaves to diffuse into water when the tea bag is placed in a water-filled container. The tea bag string has a first end and a second end, the first end connected to the tea bag. The tea bag tag connected to the second end of the tea bag string. The steep indicator is operatively associated with the tea bag system. The steep indicator displays discernable indicia that the tea bag has steeped in liquid for designated period of time.

### TECHNICAL FIELD

The present disclosure generally relates to tea bags with steep indicators and, particularly, to systems and methods for tea bags with color steep indicators that are connected by a string.

### BACKGROUND

### Description of the Related Art

Various types of teas have been consumed for thousands of years. Traditionally, tea is steeped in a pot of water. The tea leaves themselves, which are usually cut into small pieces, are placed in the pot of water either in a tea bag or “loose leaf” without a tea bag. More recently, tea bags are being used that are optimized in size for a single cup of tea, rather than a pot of tea. Tea bags are typically porous and permeable to liquids. Typically, a user submerges the tea leaves in water for a period of time. Most tea bags have a string attached to the tea bag on one end. A labeled tag is usually attached to the other end of the string. The string and attached tag enable the tea bag to be easily pulled from a pot or cup without touching the hot tea.

Using traditional definitions, the “brewing” process refers to the application of heat (e.g., hot water) to the tea, while the “steeping” process refers to the length of time in which the tea remains soaking in the water of the cup or pot. Alternatively, sometimes a user will refer to the “brewing” as the entirety of the tea preparation process and the “steeping” as only the time period during which the tea remains soaking in the water of the cup or pot.

There are several considerations to take into account in the tea preparation process. These considerations include, by way of example only, and not by way of limitation: the type of tea being brewed, the temperature at which the tea is being brewed, and the amount of time the tea is being steeped. If tea leaves are steeped too long, the tea may become astringent or bitter. Traditionally, all “true” tea comes from the Camellia sinensis tea plant, with black tea being the processed (oxidized) Camellia sinensis tea plant, oolong tea being the semi-processed (semi-oxidized) Camellia sinensis tea plant, green tea being unprocessed (unoxidized) green portions of the Camellia sinensis tea plant (e.g., stem, leaves, and the like), and white tea being unprocessed (unoxidized) light, delicate portions of the Camellia sinensis tea plant, such as the flower, bud, and the like. In contrast, herbal teas may not necessarily contain the Camellia sinensis tea plant.

Regarding the considerations for the brewing and steeping process, green and white tea are more delicate than black tea, for example, so green and white tea are steeped at a lower temperature and for shorter periods of time than black tea. In contrast, since herbal teas often do not contain the Camellia sinensis tea plant, some herbal teas can be steep much longer than a “true” tea without becoming astringent or bitter.

The steeping process can be a challenging part of the tea making process for some tea drinkers. If tea is steeped for too little time, the tea may be too weak and/or watery. In contrast, if the tea is over-steeped, the tea may become bitter and/or astringent.

Often the pot or cup that contains the tea is not transparent, so it may be difficult to monitor the change in the color of the tea, particularly if the pot or cup is covered to prevent spilling. Accordingly, there is a continuing need in the art for a system or method to monitor when tea is steeped for the proper amount of time without becoming over-steeped. Notably, some prior attempts to examine the brewing of tea merely track the temperature of the tea and/or the period of time that the tea has steeped, without actually examining the diffusion of the tea particulates into the water.

### BRIEF SUMMARY

A tea bag system may be summarized as including a tea bag including a water permeable material that contains tea leaves, the water permeable material enabling tea particulates from the tea leaves to diffusion through the water permeable material when the tea bag is placed in a water-filled container; a tea bag string having a first end and a second end, the first end connected to the tea bag; a tea bag tag connected to the second end of the tea bag string; and a steep indicator operatively associated with the tea bag tag, the steep indicator displaying discernable indicia that the tea bag has steeped in liquid for designated period of time. The steep indicator may display discernable indicia in response to contact with steeped tea. The steep indicator may display discernable indicia in response to contact with steeped tea that has wicked up the tea bag string from the water-filled container. The steep indicator may be positioned between layers of the tea bag tag. The steep indicator may be incorporated into tea bag tag. The steep indicator may be an alkaline compound that darkens after contact with the steeped tea. The steep indicator may be a chemical that displays a color after interacting with tannins, polyphenols, or acids in the steeped tea. The tea bag string may include a cotton core that is surrounded by an outer coating, the outer coating being comprised of a polymer that prevents dampness from a wet core from penetrating the outer coating. The tea bag tag may include a paper core that is surrounded by an outer coating, the outer coating being comprised of a polymer that prevents dampness from a wet core from penetrating the outer coating. The steep indicator may be operatively associated with the tea bag string in addition to the tea bag tag. The steep indicator may change to a first color at a first level of tea steeping, may change to a second color at a second level of tea steeping, and may change to a third color at a third level of tea steeping. The steep indicator may change to a first shape at a first level of tea steeping, may change to a second shape at a second level of tea steeping, and may change to a third shape at a third level of tea steeping. The steep indicator may change to a first length at a first level of tea steeping, may change to a second length at a second level of tea steeping, and may change to a third length at a third level of tea steeping.

A tea bag system may be summarized as including a tea bag including a water permeable material that contains tea leaves, the water permeable material enabling tea particulates from the tea leaves to diffuse through the water permeable material when the tea bag is placed in a water-filled container; a tea bag string having a first end and a second end, the first end connected to the tea bag; a tea bag tag connected to the second end of the tea bag string; and a steep indicator operatively associated with the tea bag system, the steep indicator displaying discernable indicia that the tea bag has steeped in liquid for designated period of time. The steep indicator may be a chemical that is positioned in the tea bag or the tea bag string. The steep indicator may be a chemical that wicks up the tea bag string to the tea bag tag. The steep indicator may be a chemical that is activated by contact with the steeped tea. The steep indicator may be a chemical that is activated by contact with the steeped tea and incorporates a time-release triggering component after contact with liquid. The steep indicator may be a chemical that is activated by contact with the steeped tea and incorporates a heat-sensitive triggering component after contact with hot liquid. The steep indicator may be a chemical that is activated by contact with the steeped tea and incorporates a water-dissolving triggering component after contact with liquid.

The steep indicator may display discernable indicia in response to contact with steeped tea. The steep indicator may display discernable indicia in response to contact with steeped tea that has wicked up the tea bag string from the water-filled container. The steep indicator may be positioned between layers of the tea bag tag. The steep indicator may be incorporated into tea bag tag. The steep indicator may be an alkaline compound that darkens after contact with the steeped tea. The steep indicator may be a chemical that displays a color after interacting with tannins, polyphenols, or acids in the steeped tea. The tea bag string may include a cotton core that is surrounded by an outer coating, the outer coating being comprised of a polymer that prevents dampness from a wet core from penetrating the outer coating. The tea bag tag may include a paper core that is surrounded by an outer coating, the outer coating being comprised of a polymer that prevents dampness from a wet core from penetrating the outer coating. The steep indicator may be operatively associated with the tea bag string in addition to the tea bag tag. The steep indicator may change to a first color at a first level of tea steeping, may change to a second color at a second level of tea steeping, and may change to a third color at a third level of tea steeping. The steep indicator may change to a first shape at a first level of tea steeping, may change to a second shape at a second level of tea steeping, and may change to a third shape at a third level of tea steeping. The steep indicator may change to a first length at a first level of tea steeping, may change to a second length at a second level of tea steeping, and may change to a third length at a third level of tea steeping.

A tea bag system may be summarized as including a tea bag including a water permeable material that contains tea leaves; a tea bag string having a first end and a second end, the first end connected to the tea bag; and a steep indicator operatively associated with the tea bag system, the steep indicator displaying discernable indicia that the tea bag has steeped in tea for designated period of time.

The system may further include a tea bag tag connected to the second end of the tea bag string. The steep indicator may be a chemical that is positioned in the tea bag or the tea bag string. The steep indicator may be a chemical that wicks up the tea bag string to the tea bag tag. The steep indicator may be a chemical that is activated by contact with the steeped tea. The steep indicator may be a chemical that is activated by contact with the steeped tea and incorporates a time-release triggering component after contact with liquid. The steep indicator may be a chemical that is activated by contact with the steeped tea and incorporates a heat-sensitive triggering component after contact with hot liquid. The steep indicator may be a chemical that is activated by contact with the steeped tea and incorporates a water-dissolving triggering component after contact with liquid. The steep indicator may display discernable indicia in response to contact with steeped tea. The steep indicator may display discernable indicia in response to contact with steeped tea that has wicked up the tea bag string from a water-filled container. The steep indicator may be positioned between layers of the tea bag tag. The steep indicator may be incorporated into the tea bag tag. The steep indicator may be an alkaline compound that darkens after contact with the steeped tea. The steep indicator may be a chemical that displays a color after interacting with tannins, polyphenols, or acids in the steeped tea. The tea bag string may include a cotton core that is surrounded by an outer coating, the outer coating being comprised of a polymer that prevents dampness from a wet core from penetrating the outer coating. The tea bag tag may include a paper core that is surrounded by an outer coating, the outer coating being comprised of a polymer that prevents dampness from a wet core from penetrating the outer coating. The steep indicator may be operatively associated with the tea bag string in addition to the tea bag tag. The steep indicator may change to a first color at a first level of tea steeping, may change to a second color at a second level of tea steeping, and may change to a third color at a third level of tea steeping.

The steep indicator may change to a first shape at a first level of tea steeping, may change to a second shape at a second level of tea steeping, and may change to a third shape at a third level of tea steeping. The steep indicator may change to a first length at a first level of tea steeping, may change to a second length at a second level of tea steeping, and may change to a third length at a third level of tea steeping.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 illustrates a tea bag system, in accordance with the present disclosure, having a tea bag, a tea bag string, and a tea bag tag.

FIG. 2 illustrates a water-filled container into which the tea bag of a tea bag system, in accordance with the present disclosure, is submerged.

FIG. 3 illustrates a tea bag system, in accordance with the present disclosure, having a tea bag, a tea bag string, a tea bag tag, and a steep indicator displayed on the tea bag tag, after the tea bag has been submerged in the water-filled container.

FIG. 4 illustrates a tea bag system, in accordance with the present disclosure, having a tea bag, a tea bag string, a tea bag tag, and a steep indicator displayed on the tea bag string, after the tea bag has been submerged in the water-filled container.

FIG. 5 illustrates a tea bag system, in accordance with the present disclosure, having a tea bag, a tea bag string, a tea bag tag, and a steep indicator displayed on the tea bag string and the tea bag tag, after the tea bag has been submerged in the water-filled container.

FIG. 6A illustrates a tea bag system, in accordance with the present disclosure, having a tea bag, a tea bag string, a tea bag tag, and a steep indicator displayed on the tea bag string to a first length, after the tea bag has been submerged in the water-filled container.

FIG. 6B illustrates a tea bag system, in accordance with the present disclosure, having a tea bag, a tea bag string, a tea bag tag, and a steep indicator displayed on the tea bag string to a second length, after the tea bag has been submerged in the water-filled container.

FIG. 6C illustrates a tea bag system, in accordance with the present disclosure, having a tea bag, a tea bag string, a tea bag tag, and a steep indicator displayed on the tea bag string to a third length, after the tea bag has been submerged in the water-filled container.

FIG. 7A illustrates a tea bag system, in accordance with the present disclosure, having a tea bag, a tea bag string, a tea bag tag, and a steep indicator displayed on the tea bag tag to a first size, after the tea bag has been submerged in the water-filled container.

FIG. 7B illustrates a tea bag system, in accordance with the present disclosure, having a tea bag, a tea bag string, a tea bag tag, and a steep indicator displayed on the tea bag string to a second larger size, after the tea bag has been submerged in the water-filled container.

FIG. 7C illustrates a tea bag system, in accordance with the present disclosure, having a tea bag, a tea bag string, a tea bag tag, and a steep indicator displayed on the tea bag string to a third largest size, after the tea bag has been submerged in the water-filled container.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one implementation” or “an implementation” means that a particular feature, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise. The headings and Abstract of the Disclosure provided herein are for convenience only and do not interpret the scope or meaning of the implementations.

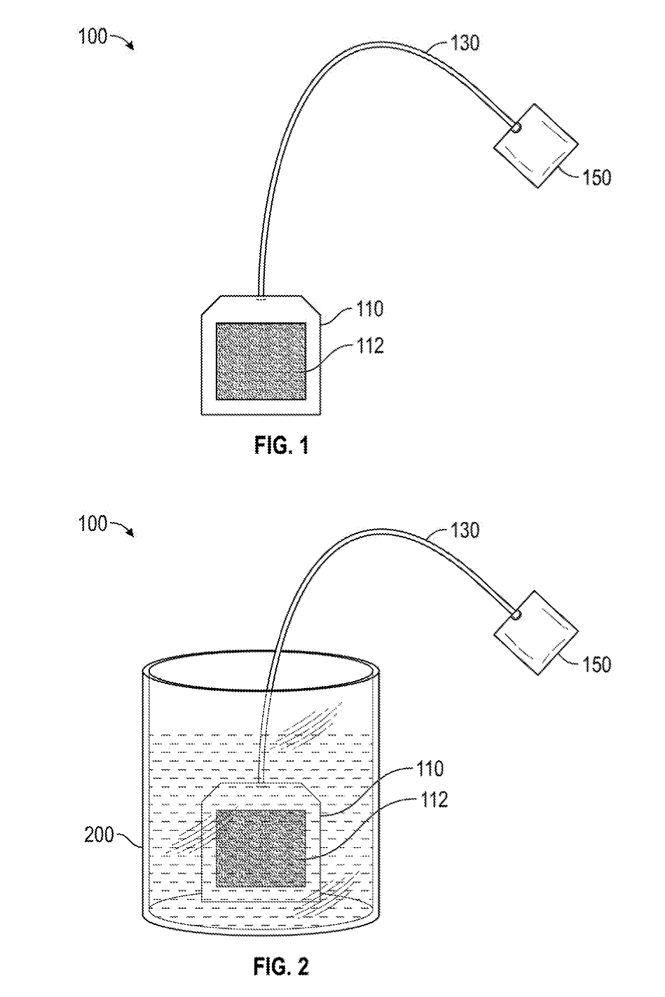

FIGS. 1 and 2 present a perspective view of a tea bag system 100 with a string-attached steep indicator, according to one implementation of this disclosure. As shown in FIG. 1, in one or more implementations, the tea bag system 100 includes a tea bag 110, a tea bag string 130, and a tea bag tag 150. The tea bag 110 contains tea leaves 112 that are used to steep a cup or pot of tea, or other tea-type beverage. It should be appreciated that the tea leaves 112 may be white tea leaves, green tea leaves, oolong tea leaves, black tea leaves, or any other desired variety of tea leaves. Alternatively or additionally, the tea leaves 112 may include herbal teas or have other types of herbs, flowers, plants, and/or spices included in the tea bag 110.

As described above, in some implementations, the tea bag system 100 includes a tea bag string 130. Referring now to FIG. 2, the tea bag string 130 is used to facilitate the removal of the tea bag 110 from a tea cup 200, tea pot, or other container in which the tea bag 110 is submerged during the steeping process. In one such implementation, the tea bag 110 is submerged in water within a tea cup 200, while at least a portion of the tea bag string 130 remains outside of the water within the tea cup 200. The tea bag string 130 enables a user to pull the tea bag string 130 and remove the tea bag 110 from the water within the tea cup 200 without touching the water, which is typically hot to the touch.

FIG. 2 displays an implementation of a tea bag 110 submerged in a cup 200 of water to prepare a cup of tea. In another implementation, the cup 200 may be replaced with a pot, a glass, a kettle, or any other known container for use in holding a quantity of liquid. The tea leaves 112 in the tea bag 110 steep within the hot cup 200 of water. Steeping is the soaking of a solid material in a liquid (e.g., water) to extract flavors from the solid material into the liquid. In tea preparation, steeping involves leaving tea leaves 112 in heated water to release the flavors and other particulates into the water.

Referring still to FIG. 2, after the tea bag 110 has been submerged in the hot cup 200 of water for a period of time, tea particulates from the tea leaves 112 in the tea bag 110 have dissolved into the water and infused the water with the tea particulates, thereby creating tea. Notably, the length of time necessary to properly steep tea may vary based any number of factors, including the type of tea, the temperature of the water, the user's taste preferences, the pH of the water, the presence of any potential contaminates in the water, the material comprising the tea bag, the porosity of the tea bag, and the like. Notably, allowing the tea bag 110 to steep in the cup 200 for a longer period of time will typically create a stronger, but potentially more bitter or astringent, tea flavor.

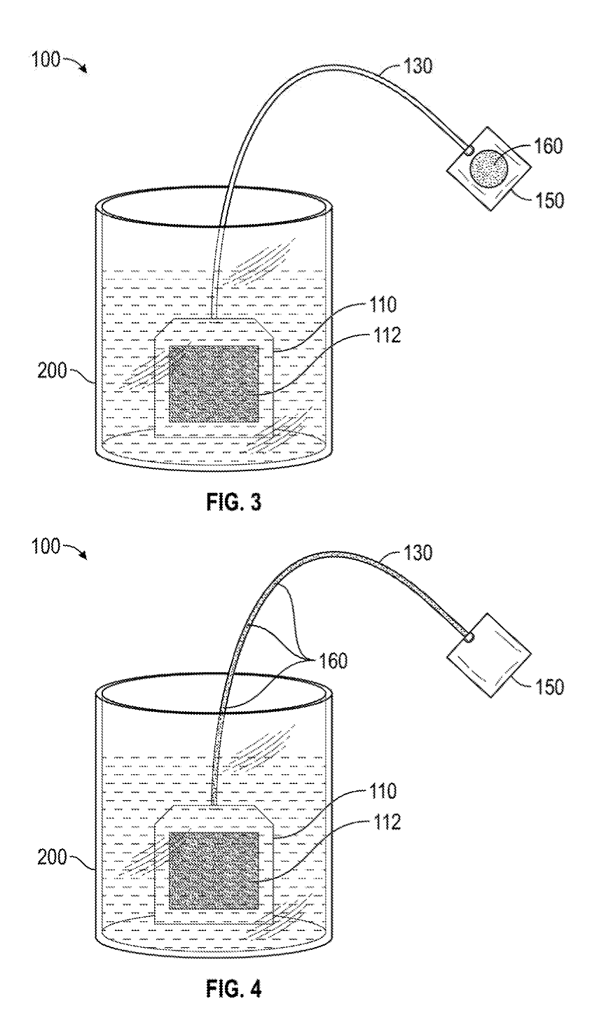

As described above, in some implementations, the tea bag system 100 includes a tea bag tag 150 attached to the end of the tea bag string 130. Traditionally, the tea bag tag 150 has served as the primary display of the tea manufacturer's logo, as well as the primary point for a user to hold the tea bag system 100 when dipping the tea bag 110 into the tea cup 200 or removing the tea bag 110 from tea cup 200. As shown in FIG. 3, in some implementations of the tea bag system 100, the tea bag tag 150 is the location of steep-related indicia 160 which specifies that the tea has steeped for a certain period of time.

In one or more implementations of the tea bag system 100, the steep-related indicia 160 on (or in) the tea bag tag 150 is activated by steeped tea wicking up the tea bag string 130 to contact the steep-related indicia 160. The steeped tea climbs the string 130 via the wicking action created by the teabag string. The wicking action is basically a capillary phenomenon in which fluid is pulled up the string 130. Capillary phenomenon is demonstrated when fluid “climbs” up a narrow tube inserted into a fluid. Notably, the fluid will climb farther as the tube gets narrower. After the steeped tea has reached the top of the cup 200, the steeped tea may then soak down the side of string external to the cup 200 and reach the steep-related indicia 160 on (or in) the tea bag tag 150.

Notably, in one or more implementations, it is the steeped tea that activates the steep-related indicia 160 on (or in) the tea bag tag 150, not just water. As such, the tea leaves must first steep into the water to create steeped tea, and then the steeped tea must be wicked up the tea bag string 130 to contact the steep-related indicia 160. This produces a longer time period to activate the steep-related indicia 160, and thus, a long steep time period. In other implementations where a short steep time period is desired, the steep-related indicia 160 on (or in) the tea bag tag 150 may by activated just by contact with the water.

As the tea leaves 112 steep, the tea leaves 112 release particles called tannins that give the tea its astringency. Additionally, polyphenols and various acids such as succinic, oxalic, malic, citric, and isocitric acid are released from tea during the steeping process. In one or more implementations of the tea bag system 100, the tea bag tag 150 includes alkaline materials (or acidic materials) that interact with the acids in the tea, and/or other materials, such as pH materials in the tea. The alkaline materials, such as liquid dish detergent, purple cabbage, and the like, will make the color of the tea darker. In contrast, acidity materials, such as lemon juice, will make the color of the tea lighter. In other implementations, other chemical reactions can also be created in the steep-related indicia 160 of the tea bag tag 150 by generating reactions with various steep tea components (e.g., tannins, polyphenols, and various acids such as succinic, oxalic, malic, citric, and isocitric add, and the like).

Accordingly, in some implementations of the tea bag system 100, when the tea leaves 112 in the tea bag 110 have sufficiently steeped into the water to create tea, the tea then wicks up the tea bag string 130 to the steep-related indicia 160 of the tea bag tag 150. The tea bag contains chemical that interact with the tannins, polyphenols, acids, and or other pH containing materials in the tea. In some implementations, the one or more steep-related indicia 160 on the tea bag tag 150 become visible when the tea has been sufficiently steeped and is ready for consumption.

Notably, the tea bag tag 150 may have initial indicia (other than the steep-related indicia 160) on its surface prior to being moistened by the steeped tea that is wicked by the tea bag string 130. That is, the tea bag tag 150 may have a logo, product name, or other initial indicia on its surface. When the tea bag tag 150 is moistened by the tea that is wicked by the tea bag string 130, the initial indicia on the surface of the tea bag tag 150 may change. For example, in some implementations, additional indicia become visible on the tea bag tag 150 after the tea bag tag 150 has been moistened by the steeped tea that is wicked by the tea bag string 130. In other implementations, at least a portion of the initial indicia is concealed, altered, or otherwise modified by the steep-related indicia 160 after the steeping process and the wicking of the tea up the tea bag string 130.

In some implementations of the tea bag system 100, the tea bag tags 150 may contain varying amounts of an indicator material for creating the steep-related indicia 160, such as alkaline materials and acidic materials to customize the color response that is produced by the steeped tea reaching the tea bag tag 150 via the wicking action of the tea bag string 130. The indicator material may be incorporated into the material of the tea bag tag 150 itself or the indicator material may be contained inside layers of the tea bag tag material, with the tea bag tag material (e.g., paper) being thin enough to be translucent and show the indicator material for creating the steep-related indicia 160 within the tea bag tag 150 when the tea bag tag 150 is wet. The steep-related indicia 160 may be shaped as a figure, logo, design, phrase, slogan, or any other desired message or image.

The one or more implementations of the tea bag tag 150 are composed of a paper or cotton material blend, while various different materials may be used in other implementations. In another implementation, the tea bag tag 150 may have a paper or cotton material blend core that is surrounded by an outer coating, such as a polymer (e.g., wax or plastic) that prevents the tea bag tag 150 from being damp to the touch when the core is wet.

In some implementations of the tea bag system 100, the tea bag string 130 is composed of simple wicking cotton. In other implementations, various different materials may be used instead of, or in addition to, the wicking cotton. In some implementations, the length of the time period that it takes fluid to wick up the tea bag string 130 may be modified by changing the components of the tea bag string 130. For example, in addition to the simple wicking cotton, a percentage of the tea bag string 130 may also be composed of non-wicking (or slower wicking) material (e.g., a polymer) to slow down the wicking of the fluid and lengthen the time period at which the steep indicator 160 is activated for a longer desired steep time. In another example, a percentage of the tea bag string 130 may also be composed of faster wicking material (e.g., a paper product) in addition to the simple wicking cotton, to speed up the wicking of the fluid and shorten the time period at which the steep indicator 160 is activated for a shorter desired steep time.

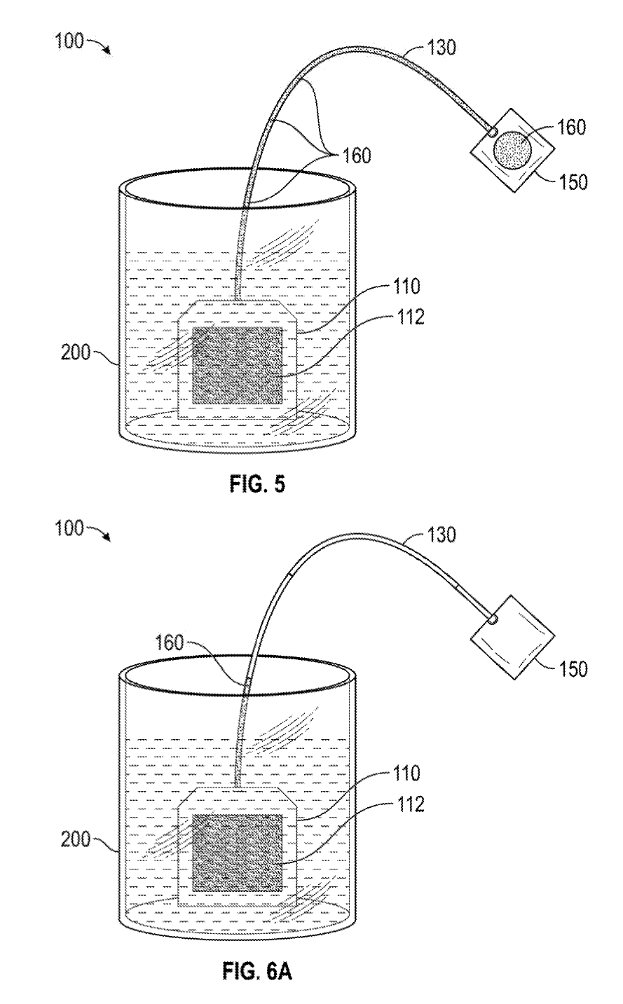

In another implementation, the tea bag string 130 may have a wicking cotton core that is surrounded by an outer coating, such as a polymer (e.g., wax or plastic) that prevents the tea bag string 130 from being damp to the touch, or leaking outside of the tea cup 200, when the core is wet. Alternatively, as shown in FIG. 4, in other implementations of the tea bag system 100, the tea bag string 130 may contain the indicator material of the steep-related indicia 160 instead of the indicator material of the steep-related indicia 160 being located in the tea bag tag 150. Additionally, as shown in FIG. 5, in other implementations of the tea bag system 100, the tea bag string 130 may contain the indicator material of the steep-related indicia 160 as well as the indicator material of the steep-related indicia 160 that is located in the tea bag tag 150.

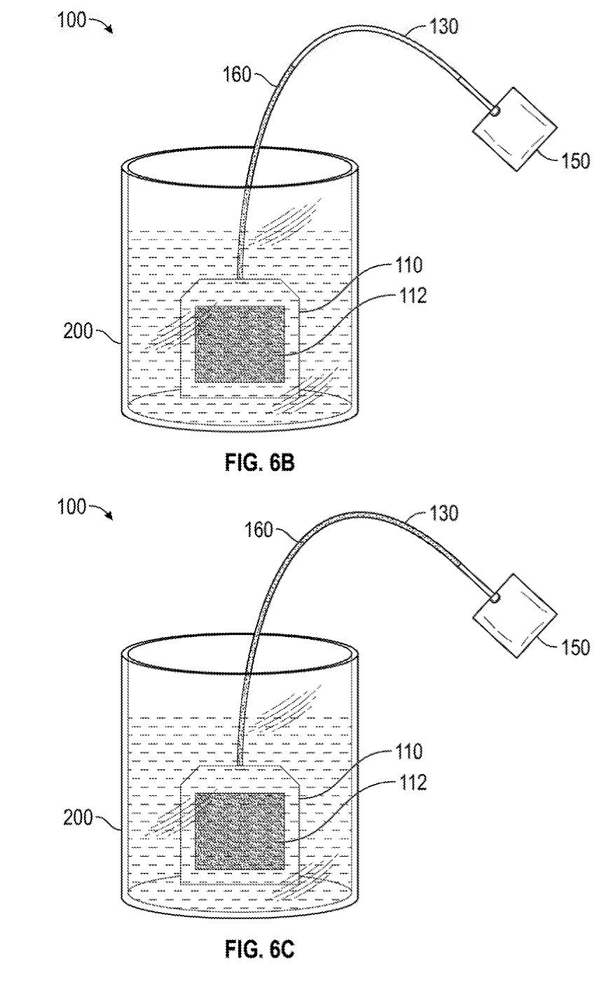

In one or more implementations of the tea bag system 100, the steep-related indicia 160 changes to a first color at a first level of tea steeping, changes to a second color at a second level of tea steeping, and changes to a third color at a third level of tea steeping. In other implementations of the tea bag system 100, the steep-related indicia 160 changes to a first length at a first level of tea steeping, changes to a second length at a second level of tea steeping, and changes to a third length at a third level of tea steeping. For example, FIG. 6A illustrates a tea bag system 100, in accordance with the present disclosure, with a steep-related indicia 160 displayed on the tea bag string 130 to a first length, after the tea bag has been submerged in a water-filled container 200. In another example, FIG. 6B illustrates a tea bag system 100, in accordance with the present disclosure, with a steep-related indicia 160 displayed on the tea bag string 130 to a second length, after the tea bag has been submerged in the water-filled container 200. In still another example, FIG. 6C illustrates a tea bag system 100, in accordance with the present disclosure, with a steep-related indicia 160 displayed on the tea bag string 130 to a third length, after the tea bag has been submerged in the water-filled container 200.

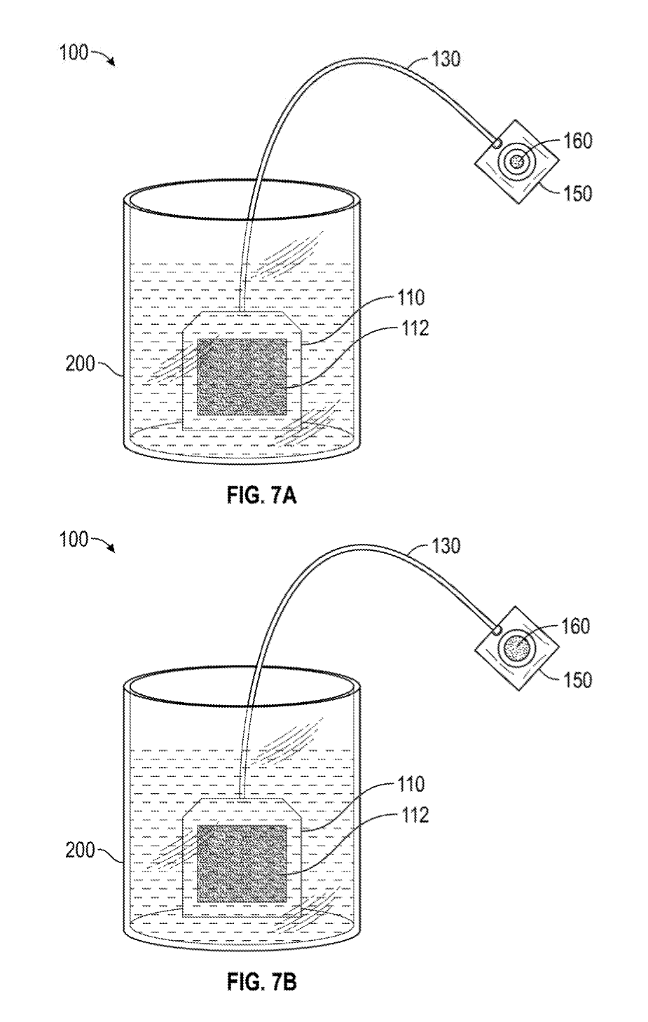

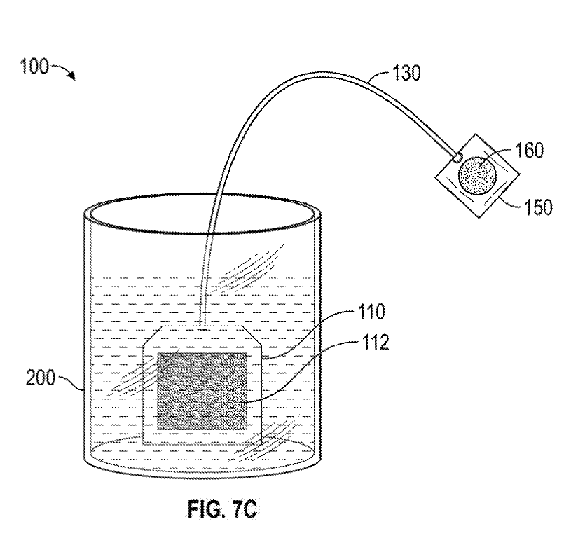

In still other implementations of the tea bag system 100, the steep-related indicia 160 changes to a first shape or size at a first level of tea steeping, changes to a second shape or size at a second level of tea steeping, and changes to a third shape or size at a third level of tea steeping. For example, FIG. 7A illustrates a tea bag system 100, in accordance with the present disclosure, with a steep-related indicia 160 displayed on the tea bag tag 150 at a first size, after the tea bag has been submerged in the water-filled container 200 until a first level of tea steeping. In another example, FIG. 7B illustrates a tea bag system, in accordance with the present disclosure, with a steep-related indicia 160 displayed on the tea bag tag 150 to a second larger size, after the tea bag has been submerged in the water-filled container 200 until a second level of tea steeping. In still another example, FIG. 7C illustrates a tea bag system, in accordance with the present disclosure, with a steep-related indicia 160 displayed on the tea bag tag 150 to a third largest size, after the tea bag has been submerged in the water-filled container 200 until a third level of tea steeping.

In yet other implementations of the tea bag system 100, indicator material may be located at the connection of the tea bag string 130 with the tea bag 110. In such an implementation, it may be the indicator material (chemical) what wicks up the tea bag string 130 rather than the steeped tea itself. In at least one implementation, the indicator material may be selected to activate in response to contact with a predetermined level of a component of the steeped tea. In another implementation, the indicator material may incorporate a time-release component and activate in response to contact with a predetermined level of a component of the steeped tea. In still another implementation, the indicator material may incorporate a heat sensitive component and activate in response to contact with a predetermined level of a component of the steeped tea. In yet another implementation, the indicator material may incorporate a water dissolving component and activate in response to contact with a predetermined level of a component of the steeped tea. In each of the above implementations, the indicator material may be selected to activate in response to contact with the steeped tea for a designated period of time, not simply in response to immediate contact with the steeped tea.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above. The various implementations described above can be combined to provide further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1.-32. (canceled)

33. A tea bag system, comprising:
a tea bag including a water permeable material that contains tea leaves;
a tea bag string having a first end and a second end, the first end connected to the tea bag; and
a steep indicator operatively associated with the tea bag system, the steep indicator displaying discernable indicia that the tea bag has steeped in tea for designated period of time.

34. The system of claim 33, further comprising a tea bag tag connected to the second end of the tea bag string.

35. The system of claim 33, wherein the steep indicator is a chemical that is positioned in the tea bag or the tea bag string.

36. The system of claim 34, wherein the steep indicator is a chemical that wicks up the tea bag string to the tea bag tag.

37. The system of claim 33, wherein the steep indicator is a chemical that is activated by contact with the steeped tea.

38. The system of claim 33, wherein the steep indicator is a chemical that is activated by contact with the steeped tea and incorporates a time-release triggering component after contact with liquid.

39. The system of claim 33, wherein the steep indicator is a chemical that is activated by contact with the steeped tea and incorporates a heat-sensitive triggering component after contact with hot liquid.

40. The system of claim 33, wherein the steep indicator is a chemical that is activated by contact with the steeped tea and incorporates a water-dissolving triggering component after contact with liquid.

41. The system of claim 33, wherein the steep indicator displays discernable indicia in response to contact with steeped tea.

42. The system of claim 33, wherein the steep indicator displays discernable indicia in response to contact with steeped tea that has wicked up the tea bag string from a water-filled container.

43. The system of claim 34, wherein the steep indicator is positioned between layers of the tea bag tag.

44. The system of claim 34, wherein the steep indicator is incorporated into the tea bag tag.

45. The system of claim 33, wherein the steep indicator is an alkaline compound that darkens after contact for the designated period of time with the steeped tea.

46. The system of claim 33, wherein the steep indicator is a chemical that displays a color after interacting with tannins, polyphenols, or acids in the steeped tea for the designated period of time.

47. The system of claim 33, wherein the tea bag string comprises a cotton core that is surrounded by an outer coating, the outer coating being comprised of a polymer that prevents dampness from a wet core from penetrating the outer coating.

48. The system of claim 34, wherein the tea bag tag comprises a paper core that is surrounded by an outer coating, the outer coating being comprised of a polymer that prevents dampness from a wet core from penetrating the outer coating.

49. The system of claim 34, wherein the steep indicator is operatively associated with the tea bag string in addition to the tea bag tag.

50. The system of claim 33, wherein the steep indicator changes to a first color at a first level of tea steeping, changes to a second color at a second level of tea steeping, and changes to a third color at a third level of tea steeping.

51. The system of claim 33, wherein the steep indicator changes to a first shape at a first level of tea steeping, changes to a second shape at a second level of tea steeping, and changes to a third shape at a third level of tea steeping.

52. The system of claim 33, wherein the steep indicator changes to a first length at a first level of tea steeping, changes to a second length at a second level of tea steeping, and changes to a third length at a third level of tea steeping.
